(19) United States
(12) Patent Application Publication
(10) Pub. No.: US 2025/0234146 A1
(43) Pub. Date: Jul. 17, 2025

(54) ELECTRONIC DEVICE AND OPERATION MODE SWITCHING METHOD THEREOF

(71) Applicant: ASUSTeK COMPUTER INC., Taipei City (TW)

(72) Inventor: Chun-Liang Lu, Taipei City (TW)

(73) Assignee: ASUSTeK COMPUTER INC., Taipei City (TW)

(21) Appl. No.: 18/963,792

(22) Filed: Nov. 29, 2024

(30) Foreign Application Priority Data
Jan. 15, 2024 (TW) 113101490

(51) Int. Cl. H04R 29/00; G01S 3/803; G06F 1/02; G06F 1/3212; G06F 1/3215; G06F 3/16

(52) U.S. Cl. CPC H04R 29/005; G01S 3/8032; G06F 1/022; G06F 1/3212; G06F 1/3215; G06F 3/16

(57) ABSTRACT

An electronic device and an operation mode switching method thereof are provided. The electronic device includes a microphone group and a processor. The microphone group includes a plurality of microphones respectively configured at different positions for multi-directional sound collection. The processor receives a plurality of external sound signals through the microphone group, and obtains a plurality of target sound signals from the plurality of external sound signals. The processor defines decibel values of the plurality of target sound signals to analyze the decibel values of the plurality of target sound signals to obtain a current environment sound decibel value. The processor switches between a plurality of operating modes with different corresponding system performances according to the environment sound decibel value.

### CROSS-REFERENCE TO RELATED APPLICATION

This application claims the priority benefit of Taiwan application serial no. 113101490, filed on Jan. 15, 2024. The entirety of the above-mentioned patent application is hereby incorporated by reference herein and made a part of this specification.

### BACKGROUND

### Technical Field

This disclosure relates to an electronic device that can dynamically adjust system performance according to the volume of an environment sound and an operating mode switching method adopted thereby.

### Description of Related Art

In traditional notebook computer designs, in order to prevent users from clearly feeling a noise caused by increased fan rotation speed when using a computer, the system performance is actively suppressed when the system load requirement is high, thereby reducing the chances of increased fan rotation speed due to an increase in the heat dissipation target temperature. However, the traditional design does not consider the experience of users toward the fan noise in the current usage scenario. Instead, the traditional design may unnecessarily sacrifice system performance. In addition, although there are different operating modes provided for users to manually switch to under different usage scenarios, the system load requirements change all the time, so users are unable to manually switch operating modes in real time.

### SUMMARY

This disclosure provides an electronic device, which includes a microphone group and a processor. The microphone group includes multiple microphones respectively configured at different positions for multi-directional sound collection. The processor is coupled to the microphone group. The processor receives multiple external sound signals through the microphone group, and obtains multiple target sound signals from the multiple external sound signals. The processor defines decibel values of the multiple target sound signals to analyze the decibel values of the multiple target sound signals to obtain a current environment sound decibel value. The processor switches between multiple operating modes with different corresponding system performances according to the environment sound decibel value.

This disclosure also provides an operation mode switching method suitable for an electronic device including a microphone group. The microphone group includes multiple microphones respectively configured at different positions for multi-directional sound collection. The above method includes the following steps. Multiple external sound signals are received through the microphone group. Multiple target sound signals are obtained from the multiple external sound signals. Decibel values of the multiple target sound signals are defined to analyze the decibel values of the multiple target sound signals to obtain a current environment sound decibel value. Multiple operating modes with different corresponding system performances are switched according to the environment sound decibel value.

Based on the above, the electronic device and the operating mode switching method thereof in this disclosure can combine an environment sound sensing technology and an automatic operating mode switching mechanism to automatically switch the operating modes in real time under different environments and usage scenarios. Therefore, users can be provided with the most appropriate system performance currently while considering the impact of the fan noise.

In order to make the features mentioned above and the advantages of this disclosure more apparent and easily understandable, the following embodiments are explained below in detail with the accompanying drawings.

### BRIEF DESCRIPTION OF THE DRAWINGS

FIG. 1 is a block diagram of an electronic device according to an embodiment of this disclosure.

FIG. 2 is a flow chart of steps of an operation mode switching method according to an embodiment of this disclosure.

FIG. 3 is an example of a default range of a sound source direction according to an embodiment of this disclosure.

FIG. 4 is an example of a decibel value of a target sound signal according to an embodiment of this disclosure.

FIG. 5 is a flow chart of steps of an operation mode switching method according to an embodiment of this disclosure.

FIG. 6 is a flow chart of steps of an operation mode switching method according to an embodiment of this disclosure.

### DETAILED DESCRIPTION OF DISCLOSED EMBODIMENTS

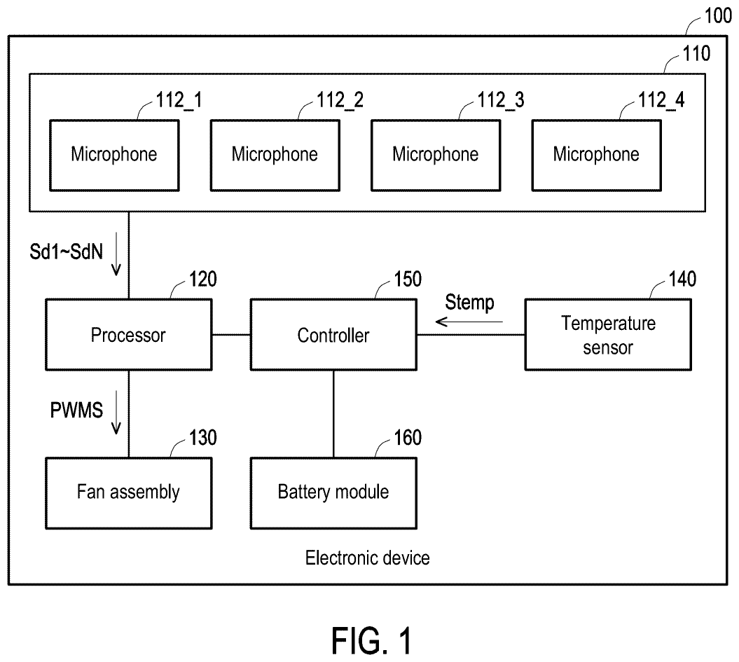

Please refer to FIG. 1. An electronic device 100 of this embodiment is, for example, an electronic product such as a notebook computer and a personal computer that can dissipate heat through a fan. The electronic device 100 includes a microphone group 110, a processor 120, a fan assembly 130, a temperature sensor 140, a controller 150, and a battery module 160.

The microphone group 110 includes microphones 112_1 to 112_4. The microphones 112_1 to 112_4 are respectively configured at different positions on the electronic device 100. For instance, the microphones 112_1 to 112_4 may be respectively configured at the top of the screen and on the left and right sides of the keyboard to perform multi-directional sound collection. It should be noted that although this embodiment is explained as including four microphones 112_1 to 112_4, the number of the microphones mentioned above is not used to limit this disclosure. Those skilled in the art may, according to the teachings of this disclosure, deduce the number of microphones to be less or more depending on actual needs.

The processor 120 is coupled to the microphone group 110 and the fan assembly 130. The processor 120 is, for example, a central processing unit (CPU), other programmable general-purpose or special-purpose microprocessors, digital signal processors (DSP), programmable controllers, application specific integrated circuits (ASIC), or other similar elements, or a combination of the above elements.

The fan assembly 130, for example, may be composed of a fan base and a fan. The fan assembly 130 may be used to adjust the rotation speed of the fan according to a pulse width modulation signal PWMS. Specifically, the rotation speed of the fan may be adjusted according to a duty cycle of the pulse width modulation signal PWMS. The longer the duty cycle, the faster the rotation speed, and the shorter the duty cycle, the slower the rotation speed. In this embodiment, the processor 120 may provide the pulse width modulation signal PWMS to the fan assembly 130 according to a current operating mode, thereby adjusting the rotation speed of the fan.

The temperature sensor 140 is, for example, any type of temperature measurement element and circuit. The temperature sensor 140 is configured inside the electronic device 100. For instance, the temperature sensor 140 may be placed near a heat-generating element (such as a central processing unit, a graphics processing unit (GPU), a solid-state disk (SSD), or a power element thereof) inside the electronic device 100, thereby regionally sensing an internal temperature of the electronic device 100 and providing a corresponding temperature signal Stemp to the controller 150.

The controller 150 is coupled to the processor 120, the temperature sensor 140, and the battery module 160. The controller 150 is, for example, an embedded controller (EC) or a microcontroller. The controller 150 may be used to estimate a system power consumption of the electronic device 100 and may convert the temperature signal Stemp received by the temperature sensor 140 to obtain the internal temperature of the electronic device 100. In addition, the controller 150 communicates with the battery module 160 through a communication protocol. The communication protocol is, for example, a system management bus (SMBus) or an inter-integrated circuit (I²C), but this embodiment is not limited thereto.

The battery module 160 may be used to supply power to the electronic device 100 and may be built-in or external. The battery module 160 includes, for example, a battery cell pack and a control circuit. The battery cell pack is composed of, for example, a single or multiple battery cells. The control circuit includes, for example, a battery gauge IC, which may calculate the stored power and the charge and discharge current of the battery module 160.

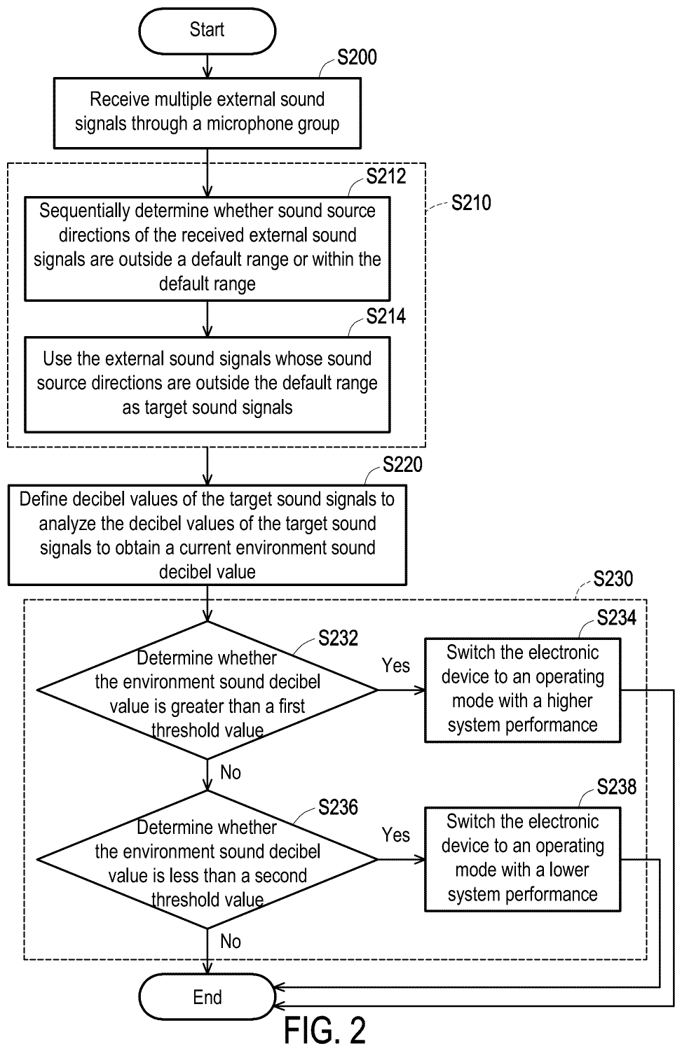

The processor 120 may load the stored firmware to execute a corresponding algorithm to implement a mode switching method of this disclosure. Please refer to FIG. 1 and FIG. 2 simultaneously. The mode switching method of this embodiment may be suitable for the electronic device 100 of FIG. 1, and the steps thereof are described as follows.

In Step S200, the processor 120 receives multiple external sound signals Sd1 to SdN through the microphone group 110. Specifically, within a time period, the microphones 112_1 to 112_4 in the microphone group 110 may perform the multi-directional sound collection, thereby allowing the processor 120 to receive the external sound signals Sd1 to SdN. N is a positive integer greater than 1.

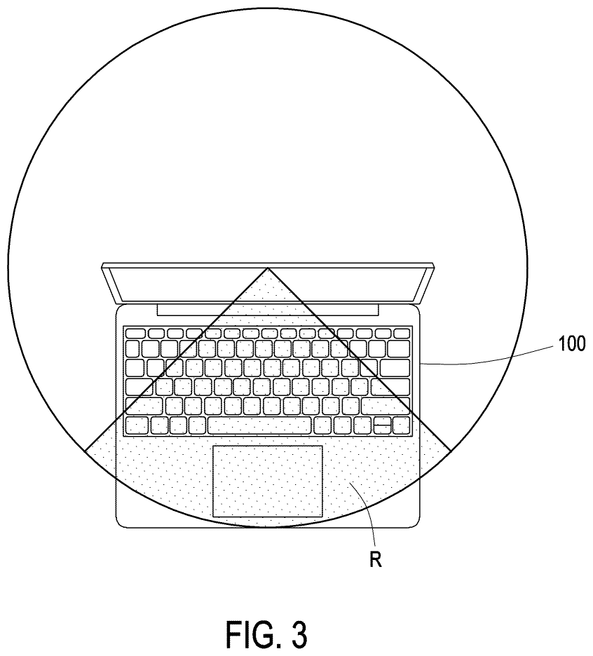

In Step S210, the processor 120 obtains multiple target sound signals St1 to StM from the external sound signals Sd1 to SdN. M is a positive integer greater than 1 and less than or equal to N. As shown in FIG. 2, Step S210 includes Step S212 and Step S214. In Step S212, the processor 120 sequentially determines whether sound source directions of the received external sound signals Sd1 to SdN are outside a default range R or within the default range R. For instance, in FIG. 3, the default range R is a fan-shaped range extending from the middle point of the screen of the electronic device 100 toward two sides of the direction of a user. The external sound signal whose sound source direction is within the default range R may be regarded as a voice of the user.

Since the positions of the microphones 112_1 to 112_4 are not the same, the processor 120 may use the misalignment difference to obtain the sound source direction of each external sound signal St1 to StM and sequentially determine whether the sound source directions of the external sound signals St1 to StM are outside the default range R or within the default range R.

In Step S214, the processor 120 uses the external sound signals whose sound source directions are outside the default range R as the target sound signals St1 to StM to exclude the voice of the user.

Next, in Step S220, the processor 120 defines the decibel values of the target sound signals St1 to StM to analyze the decibel values of the target sound signals St1 to StM to obtain a current environment sound decibel value. Specifically, the processor 120 may define the decibel values of the target sound signals St1 to StM through an application programming interface (API), and sort the decibel values of the target sound signals St1 to StM obtained within a time period (for example, 10 seconds) to obtain the current environment sound decibel value according to a sorting result.

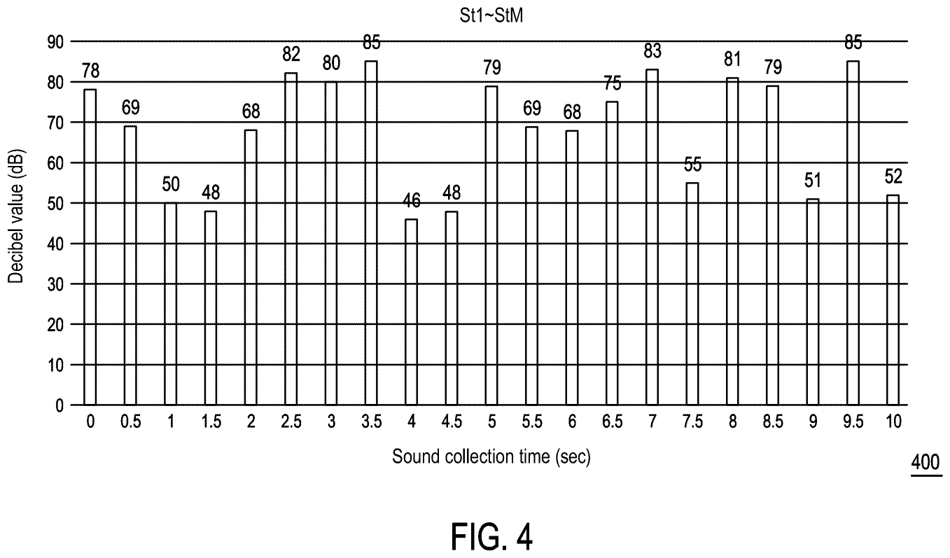

For instance, please refer to FIG. 4. In this example, the processor 120 uses the decibel values as the vertical axis and the sound collection time as the horizontal axis to sort the decibel values of the target sound signals St1 to StM to draw a bar chart 400. In FIG. 4, the interval between the sound collection times of the target sound signals St1 to StM is 0.5 seconds, but this disclosure is not limited thereto.

According to the bar chart 400, the two lowest decibel values among the decibel values of the target sound signals St1 to StM are 46 dB and 48 dB, respectively. In this scenario, the processor 120 may average the two lowest decibel values (46 decibels and 48 decibels) among the decibel values of the target sound signals St1 to StM obtained within the time period as the environment sound decibel value (47 dB). Thus, intermittent human voices and other non-continuous sound sources in the target sound signals St1 to StM may be eliminated to generate the environment sound decibel value that may respond to an environmental background sound.

Please return to FIG. 2. In Step S230, the processor 120 switches between the operating modes with different corresponding system performances according to the environment sound decibel value. In this embodiment, the operating modes of the electronic device 100 include, for example, an energy-saving mode (or a whisper mode), a standard mode, and a performance mode. Regarding the limitation of system performance, the system performance of the performance mode is greater than the system performance of the standard mode, and the system performance of the standard mode is greater than the system performance of the energy-saving mode. The maximum heat dissipation capacity of the performance mode is, for example, set at 70 watts, the maximum heat dissipation capacity of the standard mode is, for example, set at 55 watts, and the maximum heat dissipation capacity of the energy-saving mode is, for example, set at 45 watts.

As shown in FIG. 2, Step S230 includes Step S232, Step S234, Step S236, and Step S238. In Step S232, the processor 120 determines whether the environment sound decibel value is greater than a first threshold value.

When the environment sound decibel value is greater than the first threshold value (for example, 63 dB), in Step S234, the processor 120 switches the electronic device 100 to an operating mode with a higher system performance. Specifically, the processor 120 sequentially switches the electronic device 100 to the operating mode with the next higher system performance. In other words, if the current operating mode is the energy-saving mode, the electronic device 100 is switched to the standard mode, and if the current operating mode is the standard mode, the electronic device 100 is switched to the performance mode.

When the environment sound decibel value is not greater than the first threshold value, in Step S236, the processor 120 determines whether the environment sound decibel value is less than a second threshold value.

When the environment sound decibel value is less than the second threshold value (for example, 41 dB), in Step S238, the processor 120 switches the electronic device 100 to an operating mode with a lower system performance. Specifically, the processor 120 sequentially switches the electronic device 100 to the operating mode with the next lower system performance. In other words, if the current operating mode is the performance mode, the electronic device 100 is switched to the standard mode, and if the current operating mode is the standard mode, the electronic device 100 is switched to the energy-saving mode.

Through the above method, the electronic device 100 of this embodiment can introduce the sensing of environment sound, and use the characteristic of the environment sound decibel value reducing the perception of the fan noise by the user to automatically switch the operating modes in real time, which helps to improve the system performance.

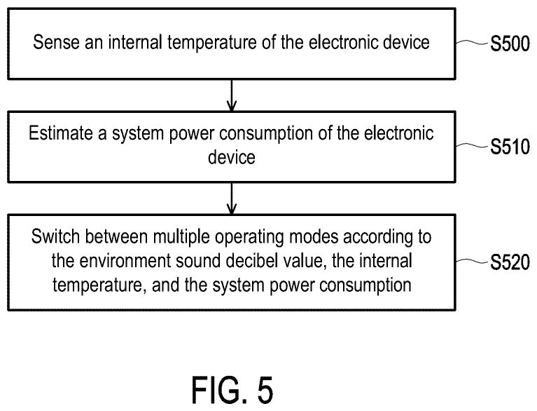

In an embodiment, the electronic device 100 may switch between the operating modes according to the environment sound decibel value, the internal temperature, and the system power consumption. Precisely, please refer to FIG. 1 and FIG. 5 simultaneously. The mode switching method of this embodiment may be suitable for the electronic device 100 of FIG. 1, and the steps thereof are described as follows.

In Step S500, the temperature sensor 140 is used to sense the internal temperature of the electronic device 100. Specifically, the temperature sensor 140 regionally senses the internal temperature of the electronic device 100 and provides the corresponding temperature signal Stemp to the controller 150.

Next, in Step S510, the controller 150 estimates the system power consumption of the electronic device 100. Specifically, the controller 150 may estimate the system power consumption of the electronic device 100 according to the system load caused by the internal elements of the electronic device 100. In addition, the controller 150 may provide the internal temperature obtained by converting the temperature signal Stemp provided by the temperature sensor 140 and the system power consumption to the processor 120.

Finally, the processor 120 switches between the operating modes according to the environment sound decibel value, the internal temperature, and the system power consumption. To be specific, Tables 1 to 3 below illustrate to the manners of switching between the operating modes according to the environment sound decibel value, the internal temperature, and the system power consumption when the current operating modes are the energy-saving mode, the standard mode, and the performance mode, respectively.

TABLE 1

| Current | Environment | System power | Internal | Mode |
|---|---|---|---|---|
| operating | sound decibel | consumption | temperature | switching |
| mode | value | (CPU wattage) | (Celsius) | manner |
| Energy- | <41 (dB) | <12 (W) | <53 degrees | Maintain |
| saving mode | | | 53~61 | energy-saving |
| | | | degrees | mode |
| | | | >61 degrees | |
| | >41 (dB) | <12 (W) | <53 degrees | Switch to |
| | | | 53~61 | standard mode |
| | | | degrees | |
| | | | >61 degrees | |

TABLE 2

| Current | Environment | System power | Internal | Mode |
|---|---|---|---|---|
| operating | sound decibel | consumption | temperature | switching |
| mode | value | (CPU wattage) | (Celsius) | manner |
| Standard | <41 (dB) | <12 (W) | <53 degrees | Switch to |
| mode | | | 53~61 | energy-saving |
| | | | degrees | mode |
| | | | >61 degrees | |
| | | 12~35 (W) | <53 degrees | Maintain |
| | | | 53~61 | standard mode |
| | | | degrees | |
| | | | >61 degrees | |
| | 41~63 (dB) | <12 (W) | <53 degrees | Maintain |
| | | | 53~61 | Standard Mode |
| | | | degrees | |
| | | | >61 degrees | |
| | | 12~35 (W) | <53 degrees | |
| | | | 53~61 | |
| | | | degrees | |
| | | | >61 degrees | |
| | >63 (dB) | <12 (W) | <53 degrees | Switch to |
| | | | 53~61 | performance |
| | | | degrees | mode |
| | | | >61 degrees | |
| | | 12~35 (W) | <53 degrees | |
| | | | 53~61 | |
| | | | degrees | |
| | | | >61 degrees | |

TABLE 3

| Current | Environment | System power | Internal | Mode |
|---|---|---|---|---|
| operating | sound decibel | consumption | temperature | switching |
| mode | value | (CPU wattage) | (Celsius) | manner |
| Performance | <63 (dB) | <12 (W) | <53 degrees | Switch to |
| mode | | | 53~61 | standard mode |
| | | | degrees | |
| | | | >61 degrees | |
| | | 12~35 (W) | <53 degrees | |
| | | | 53~61 | |
| | | | degrees | |
| | | | >61 degrees | |
| | | >35 (W) | <53 degrees | Maintain |
| | | | 53~61 | performance |
| | | | degrees | mode |
| | | | >61 degrees | |
| | >63 (dB) | <12 (W) | <53 degrees | Maintain |
| | | | 53~61 | performance |
| | | | degrees | mode |
| | | | >61 degrees | |
| | | 12~35 (W) | <53 degrees | |
| | | | 53~61 | |
| | | | degrees | |
| | | | >61 degrees | |
| | | >35 (W) | <53 degrees | |
| | | | 53~61 | |
| | | | degrees | |
| | | | >61 degrees | |

According to Tables 1 to 3, compared to other factors such as the internal temperature and the system power consumption, the environment sound decibel value has a greater impact on switching the operating modes and has a higher priority. In addition, in practical applications, the determinations of conditions such as the environment sound decibel value, the internal temperature, and the system power consumption must all last 20 seconds before being established.

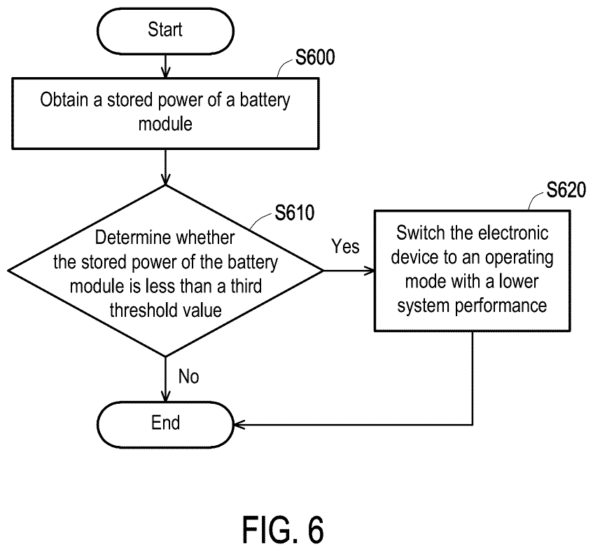

In an embodiment, the electronic device 100 may switch between the operating modes according to the stored power consumption of the battery module 160. Precisely, please refer to FIG. 1 and FIG. 6 simultaneously. The mode switching method of this embodiment may be suitable for the electronic device 100 of FIG. 1m and the steps thereof are described as follows.

In Step S600, the processor 120 obtains a stored power of the battery module 160 from the controller 150.

Next, in Step S610, the processor 120 determines whether the stored power of the battery module 160 is less than a third threshold value. When the stored power of the battery module 160 is less than the third threshold value (for example, 25% of the total battery power), in Step S620, the processor 120 switches the electronic device 100 to an operating mode with a lower system performance. Specifically, the processor 120 sequentially switches the electronic device 100 to the operating mode with the next lower system performance. In other words, if the current operating mode is the performance mode, the electronic device 100 is switched to the standard mode, and if the current operating mode is the standard mode, the electronic device 100 is switched to the energy-saving mode. Thereby, the processor 120 may switch between the operating modes according to the stored power of the battery module 160.

It is noted that during the operating period of the electronic device 100, the processor 120 repeatedly executes the mode switching method (that is, each step shown in FIG. 2, FIG. 5, and FIG. 6) of this disclosure every preset period in order to continuously and dynamically adjust the electronic device 100 to the most appropriate operating mode.

To sum up, the electronic device and the operation mode switching method thereof of this disclosure can analyze the environment sounds that affect the perception of the fan noise by the user through the environment sound sensing technology. Moreover, the automatic operating mode switching mechanism can be combined to automatically switch the operating modes in real time under different environments and usage scenarios. Thus, users can be provided with the most appropriate system performance currently while considering the impact of the fan noise.

What is claimed is:

1. An electronic device, comprising:
a microphone group, comprising a plurality of microphones, wherein the plurality of microphones are respectively configured at different positions for multi-directional sound collection; and
a processor, coupled to the microphone group, receiving a plurality of external sound signals through the microphone group, and obtaining a plurality of target sound signals from the plurality of external sound signals, wherein
the processor defines decibel values of the plurality of target sound signals to analyze the decibel values of the plurality of target sound signals to obtain a current environment sound decibel value; and
the processor switches between a plurality of operating modes with different corresponding system performances according to the environment sound decibel value.

2. The electronic device according to claim 1, further comprising:
a fan assembly, coupled to the processor and used to adjust a rotation speed of a fan according to a pulse width modulation signal,
wherein the processor provides the pulse width modulation signal to the fan assembly according to the system performance corresponding to the current operating mode to adjust the rotation speed of the fan.

3. The electronic device according to claim 1, wherein the processor sequentially determines whether sound source directions of the plurality of received external sound signals are outside a default range or within the default range,
the processor uses the plurality of external sound signals whose sound source directions are outside the default range as the plurality of target sound signals.

4. The electronic device according to claim 1, wherein the processor sorts the decibel values of the plurality of target sound signals obtained within a time period to obtain the current environment sound decibel value according to a sorting result.

5. The electronic device according to claim 4, wherein the processor averages two lowest decibel values among the decibel values of the plurality of target sound signals obtained within the time period to be used as the environment sound decibel value.

6. The electronic device according to claim 1, wherein the processor determines whether the environment sound decibel value is greater than a first threshold value,
when the environment sound decibel value is greater than the first threshold value, the processor switches the electronic device to the operating mode with the higher system performance,
the processor determines whether the environment sound decibel value is less than a second threshold value,
when the environment sound decibel value is less than the second threshold value, the processor switches the electronic device to the operating mode with the lower system performance.

7. The electronic device according to claim 1, further comprising:
a temperature sensor, used to sense an internal temperature of the electronic device; and
a controller, coupled to the processor and the temperature sensor, and used to estimate a system power consumption of the electronic device and provide the internal temperature obtained by the temperature sensor and the system power consumption to the processor,
wherein the processor switches between the plurality of operating modes according to the environment sound decibel value, the internal temperature, and the system power consumption.

8. The electronic device according to claim 7, further comprising:
a battery module, coupled to the controller and used to supply power to the electronic device,
wherein the processor obtains a stored power of the battery module from the controller, and switches between the plurality of operating modes according to the stored power.

9. An operation mode switching method, suitable for an electronic device comprising a microphone group, the microphone group comprising a plurality of microphones, and the plurality of microphones being respectively configured at different positions for multi-directional sound collection, the operation mode switching method comprising:
receiving a plurality of external sound signals through the microphone group;
obtaining a plurality of target sound signals from the plurality of external sound signals;
defining decibel values of the plurality of target sound signals to analyze the decibel values of the plurality of target sound signals to obtain a current environment sound decibel value; and
switching between a plurality of operating modes with different corresponding system performances according to the environment sound decibel value.

10. The operation mode switching method according to claim 9, wherein the electronic device further comprises a fan assembly, the operation mode switching method further comprising:
providing the pulse width modulation signal to the fan assembly according to the system performance corresponding to the current operating mode to adjust a rotation speed of a fan.

11. The operation mode switching method according to claim 9, wherein the step of obtaining the plurality of target sound signals from the plurality of external sound signals comprises:
sequentially determining whether sound source directions of the plurality of received external sound signals are outside a default range or within the default range; and
using the plurality of external sound signals whose sound source directions are outside the default range as the plurality of target sound signals.

12. The operation mode switching method according to claim 9, wherein the step of analyzing the decibel values of the plurality of target sound signals to obtain the current environment sound decibel value comprises:
sorting the decibel values of the plurality of target sound signals obtained within a time period to obtain the current environment sound decibel value according to a sorting result.

13. The operation mode switching method according to claim 12, wherein the step of obtaining the current environment sound decibel value according to the sorting result comprises:
averaging two lowest decibel values among the decibel values of the plurality of target sound signals obtained within the time period by the processor to be used as the environment sound decibel value.

14. The operation mode switching method according to claim 9, wherein the step of switching between the plurality of operation modes with different corresponding system performances according to the environment sound decibel value comprises:
determining whether the environment sound decibel value is greater than a first threshold value;
when the environment sound decibel value is greater than the first threshold value, switching the electronic device to the operating mode with the higher system performance;
determining whether the environment sound decibel value is less than a second threshold value; and
when the environment sound decibel value is less than the second threshold value, switching the electronic device to the operating mode with the lower system performance.

15. The operation mode switching method according to claim 9, further comprising:
sensing an internal temperature of the electronic device;
estimating a system power consumption of the electronic device; and
switching between the plurality of operating modes according to the environment sound decibel value, the internal temperature, and the system power consumption.

16. The operation mode switching method according to claim 15, wherein the electronic device further comprises a battery module, the operation mode switching method further comprising:
obtaining a stored power of the battery module; and
switching between the plurality of operating modes according to the stored power of the battery module.
